(19) United States
(12) Patent Application Publication
(10) Pub. No.: US 2010/0242793 A1
(43) Pub. Date: Sep. 30, 2010

(54) DARK PIGMENTS REFLECTING IR RADIATION, METHOD FOR THE PRODUCTION THEREOF, AND USE THEREOF

(76) Inventors: Marco Greb, Nurnberg (DE); Michael Grüner, Auerbach (DE); Thomas Schuster, Lauf (DE)

Correspondence Address: OSTROLENK FABER GERB & SOFFEN, 1180 AVENUE OF THE AMERICAS, NEW YORK, NY, 100368403, US

(21) Appl. No.: 12/665,083

(22) PCT Filed: Jun. 9, 2008
(86) PCT No.: PCT/EP2008/004581

§ 371 Date: Dec. 17, 2009

(30) Foreign Application Priority Data
Jun. 20, 2007 (DE) 10 2007 028 842.7

(51) Int. Cl. C09D 11/02; C09C 1/62; C09C 1/64; B05D 7/00; C09D 1/00

(52) U.S. Cl. 106/31.65; 106/403; 106/404; 427/160; 106/286.1

(57) ABSTRACT

The invention relates to an IR radiation-reflecting pigment comprising a platelet-shaped, metallic, IR-reflecting core, the IR radiation-reflecting core being provided with a substantially enveloping coating whose absorption for IR radiation is substantially low, and the IR-reflecting pigment being substantially dark. The invention further relates to a method of producing these pigments and also to the use thereof.

The invention relates to substantially dark pigments which are able to reflect IR radiation, to methods of producing them, and to the use thereof.

The property of reflecting IR radiation plays an important part in the objective of reducing the thermal heating of surfaces. Thus coating materials, inks or paints are composed of a range of components such as solvents, pigments, additives, fillers, etc. These components are able at least in part to absorb electromagnetic radiation, and this, in the case of the action of insolation, for example, leads to increasing heating of the coating and of the article coated therewith (e.g., building exteriors).

Such warming is brought about in particular as a result of the addition of dark coloring pigments (e.g., carbon black), a phenomenon attributable to the specifically high degrees of absorption both in the UV/Vis range and in the IR spectral range. The reason for the interest in pigments and applications in which these are added, such as coating materials able to reflect IR radiation, for example, is that, through reflection of the thermal radiation, it is possible to achieve a significant reduction in the heating of the article.

In comparison with their light-colored counterparts, dark pigments generally display a higher level of absorptivity in the solar range, i.e., the spectral range of UV/Vis-IR radiation. Accordingly the phenomenon of heating due to irradiated sunlight occurs to an increased extent. For this reason, dark IR-reflecting pigments are the focus of interest for—for example—coating materials in construction, surface coatings or inks and paints for textiles.

Another important field of use of IR-reflecting pigments is their use for military camouflage paints. The capacity to reflect IR radiation implies a reduced absorption capacity in this spectral range, so allowing the IR signature of objects to be modified.

WO 2005/007754 A1 describes an IR-reflecting pigment having a reflecting core and an IR-transparent material as a partial or total coating on the surface. Said reflecting core has a layer thickness of less than 0.2 μm. The IR-transparent material comprises a nonpolar or weakly polar organic polymer that optionally comprises a dye or colored material.

The systems in question there, however, are not dark pigments. Disadvantageously, the very thin aluminum pigments to be used as a substrate are accessible only via expensive and complicated PVD methods. The specific surface area of pigments of this kind is very high, and the pigments would be very difficult—if it were to be possible at all—to color uniformly with sufficiently high quantities of dark color pigments. Moreover, the pigments in accordance with the teaching of WO 2005/007754 A1 have an extremely high agglomeration tendency.

WO 2006/085563 A1 describes a dark color pigment for IR reflection, composed of mixed oxides with iron and cobalt as majority components and Mg, Ca, Sr, Ba, Ti, Zn, and Cu as a minority component. The pigments described have a particle size of 0.02-5 μm and an L* value<30. Pigments of this kind are already available commercially in a similar form. In this case the capacity for efficient reflection of IR radiation is very limited.

EP 1217044 B1 discloses composite pigments which reflect IR radiation. The colorants in question are colorants which are non-absorbing for IR radiation, i.e., are IR-transparent—that is, at least one organic dark color pigment and a white pigment (e.g., TiO₂, ZnO, etc.) which is enveloped by the corresponding IR-transparent, organic, black color pigment. A disadvantage here is that organic, black color pigments are generally not lightfast. A further disadvantages is that the TiO₂ particles are photoactive. This results in decomposition of the organic color pigments in exterior applications.

Furthermore, the pigments disclosed are spherical and therefore limited in their reflectances as a result of limited reflection geometry.

From DE 1264654 it is known that the organic triphenyl dye Kohlschwarz [“coal black”], deposited on an inorganic support, can be used as a constituent for the reflection of IR radiation in camouflage paints.

U.S. Pat. No. 6,468,647 B1 describes a base structure having an outer metallic surface into which color pigments are burnished. A disadvantage here is that, in the pigments thus produced, sufficient adhesion of the color pigments is not ensured.

U.S. Pat. No. 4,011,190 discloses black particles having a metallic reflector core that are coated with a dark material that exhibits high absorption and low emission in the solar wavelength range. This kind of pigment is used for the selective absorption of solar radiation. The objective of using these dark pigments is not that of reflection, but rather that of absorption for specific warming.

The specification WO 2005/030878 A1 discloses an IR radiation-reflecting organic, dark color pigment which is composed proportionally of substituted copper phthalocyanine pigments and perylenetetracarboxylic diimide pigments. A disadvantage here is that, as a general rule, organic color pigments do not have long-term stability.

DE 195 01 307 A1 discloses colored aluminum pigments for which color pigments are bound into a metal oxide matrix which is produced by a sol-gel process. The resultant aluminum pigments are colored, i.e., are not dark, and, furthermore, are metallically lustrous, and serve therefore for decorative purposes.

U.S. Pat. No. 5,037,475 discloses metal pigments which are likewise colored, the metal pigments being coated with color pigments. These metallic and colored pigments are used for producing bright paints, printing inks or plastics. In this case the attachment of the color pigments is via a thermally polymerized, unsaturated, polyfunctional carboxylic acid and also via a plastic covering. Likewise disadvantageous is that the colored aluminum pigments thus produced have a distinctly metallic and hence lustrous appearance.

WO 91/04293 as well discloses metal pigments which are likewise colored and metallically lustrous.

DE 40 35 062 A1 discloses an IR-reflecting substrate coated with a varnish layer which may comprise white, gray, black or chromatic pigments. Always described there is a mixture of metal pigments and color pigments. These pigments have the disadvantage that the two pigments may separate in certain applications.

The generation of dark or black, IR radiation-reflecting pigments represents a particular challenge: sunlight which reaches to the surface of the Earth in the form of radiation can be divided essentially into three subranges: 3% of the energy reaching the surface covers the UV spectral range (295-400 nm), almost 50% the visible range (400-700 nm), and 47% the NIR range (700-2500 nm). The MIR and FIR range above >2500 nm contribute only minor fractions of the sunlight.

Dark pigments have per se high degrees of absorption in the UV/VIS spectral range; they induce increased energy absorption and thereby support increased thermal heating of the pigmented material.

Pigments which efficiently reflect IR radiation and so inhibit thermal heating of materials harbor a great potential and are of very great interest. For example, by means of correspondingly pigmented masonry paint (as in the case of roof coatings, for example), it is possible to bring about a reduction in the heating of buildings under insolation. This would be accompanied by considerable energy savings in the buildings sector. As a result of reduced heating-up of buildings, it would not be necessary, for example, to employ so much energy for air conditioning, which in turn would result in considerable savings in costs and raw materials. The savings as a result of the reduced heating possible are accompanied by further advantages such as an increased lifetime of materials. For example, the wear of materials would be likewise significantly reduced as a result of decreased energy absorption or heat-induced expansion and contraction.

In the military sector there is a high demand for IR-reflecting pigments with which there is no bleeding. This applies in particular to their use in textiles, in which case the IR radiation-reflecting pigments are required to possess dark, inconspicuous camouflage colors.

It is an object of the invention to provide pigments which are capable of efficiently reflecting IR radiation. These pigments are to be largely hiding, but not to have a decorative metallic effect, and in particular should not be metallically lustrous. Furthermore, the pigments are not to separate in the application medium—that is, dark color effect, high IR reflection, and absence of decorative metallic effect are always to be coupled with one another. Furthermore, the intention is that a corrosion-stable pigment should be provided that can be used, for example, in aqueous ink and paint systems.

The object of the invention is achieved through provision of an IR radiation-reflecting pigment comprising a platelet-shaped, metallic, IR-reflecting core, the IR radiation-reflecting core being provided with a substantially enveloping coating whose absorption for IR radiation is substantially low, and the IR-reflecting pigment being substantially dark.

Preferred embodiments are specified in dependent claims 2 to 18.

The object on which the invention is based is further achieved through provision of a method of producing an IR radiation-reflecting pigment of any of claims 1 to 18, in which a platelet-shaped, metallic, IR radiation-reflecting core is enveloped with a dark coating whose absorption for IR radiation is substantially low.

Preferred developments of the method of the invention are specified in dependent claims 20 to 23.

The object of the invention is also achieved through the use of an IR radiation-reflecting pigment of any of claims 1 to 18 in paints, varnishes, printing inks, security inks, textiles, military applications or plastics.

The object on which the invention is based is likewise achieved by a coating composition, the coating composition comprising an IR radiation-reflecting pigment of any of claims 1 to 18.

A preferred development is specified in dependent claim 26.

Finally, the object of the invention is also achieved by a coated article, the article being coated with an IR radiation-reflecting pigment of any of claims 1 to 18 or a coating composition of claim 25 or 26.

The inherent property of the majority of metals to reflect IR radiation has been known for a long time; for instance, aluminum pigments are used for the reflection of IR radiation.

It has now been found, surprisingly, that it is possible, by means of a suitable coating of the pigments, to encapsulate or envelop the metallic core in such a way that the typical metallic appearance, i.e., metal luster, sparkle, light/dark flop (metallic flop), can be efficiently suppressed, producing substantially dark pigments, with retention of a pronounced reflection capacity in the IR spectral range. The pigments retain these properties even after dispersing in the application medium, because the dark coating is firmly connected to the metallic, IR-reflecting core.

The inventors have found, surprisingly, that the metallic reflection capacity of platelet-shape metallic cores or substrates can be utilized effectively for the reflection of IR radiation and at the same time the metallic luster, sparkle, and flop can be suppressed. The initial expectation was that either the metallic gloss, sparkle, and flop would not be able to be suppressed, or, alternatively, that the IR reflection capacity would be significantly impaired. Surprisingly, however, in metallic substrates, such as metallic effect pigments, it is possible to suppress their typical properties, such as metallic luster, sparkle, and flop, without substantially impairing the IR reflection capacity.

The pigments of the invention, depending on coating, can have different dark and, in particular, nonlustrous colors.

The pigments of the invention can be used in colorless applications for coloring, to give correspondingly dark-colored masstones. In colored applications, the pigments obtained may also be used for tinting.

The pigments of the invention largely no longer have a decorative metallic effect. A decorative metallic effect in the context of this invention means typical properties of metallic effect pigments such as the metallic luster, sparkle, and light/dark flop. These properties are defined further below.

Dark in the sense of the invention means that the pigment of the invention, in a pigmented and hidingly applied nitrocellulose varnish (NC varnish), has an L* value (CIELAB colorimetry, diffuse color measurement over all spatial angles by means of an integration sphere, using Minolta instrument CR-410) of L*<50, preferably L*<45, and more preferably L*<40.

Metallic effect pigments exhibit a typical light/dark flop. To assess this property, in contrast to the diffuse measurement, a measurement over different spatial angles is employed. The pigments of the invention exhibit a largely angle-independent lightness, i.e., do not have any significant lightness flop.

This lightness flop is specified by DuPont in accordance with the following formula (A. B. J. Rodriguez, JOCCA, (1992(4)) pp. 150-153):

$$Flop index = 2.69 \times \frac{{( {L}_{15 °}^{*} - {L}_{110 °}^{*} )}^{1.11}}{{( {L}_{45 °}^{*} )}^{0.86}}$$

The flop index reproduces the characteristic lightness flop particularly of metallic effect pigments.

In a correspondingly pigmented and hidingly applied NC varnish, the pigments of the invention possess a lightness flop of 0 to 2, preferably of 0.01 to 2 and more preferably of 0.05 to 1.0.

These extremely low values show that the lightness flop otherwise so typical of metallic effect pigments, for example, with a flop index in a range from approximately 4 to 25, is largely or completely suppressed in the case of the pigments of the invention.

For the production of the pigment of the invention, a platelet-shaped, metallic, IR-reflecting core is coated substantially uniformly with color pigments that are dark, i.e., that absorb in the optical wavelength range. A platelet-shaped core in the sense of the invention is a platelet having a form factor, i.e., the ratio of average size to average thickness, of 5 to 500, preferably of 10 to 200, and more preferably of 20 to 150. Platelet-shaped cores or substrates, in contrast to spherical or ellipsoidal shapes, possess the greatest IR reflection for the lowest consumption of material. Platelet-shaped pigments have reflection surfaces that in large part have the same direction.

The platelet-shaped metal pigments are opaque both for optical light and for IR radiation. Even on nonplanar substrates, platelet-shaped metal pigments produce the most effective directed and/or diffuse reflection of incident IR radiation.

Platelet-shaped metal pigments employed are preferably platelet-shaped pigments of aluminum, copper, zinc, tin, titanium, iron, silver and/or alloys of these metals. Particular preference is given to aluminum and alloys of aluminum, on the basis of the extremely high IR reflection and ready availability of these metal pigments.

The size, i.e., the dimensions of length and width, of the platelet-shaped metal pigments are situated preferably in a range from 3 to 250 μm and more preferably from 10 to 200 μm.

The average value of the sizes, i.e., of the length and width of the platelet-shaped substrates, is represented as the d₅₀ value of the volume-average cumulative undersize distribution. It is determined typically by means of laser diffraction methods.

The d₅₀ value of the platelet-shaped metallic substrates is situated preferably in a range from 25 to 150 μm and more preferably from 30 to 80 μm. These values are determined using a Cilas 1064 instrument from the French company Cilas.

It has proven advantageous to use relatively coarse-particle metal pigments as substrates. At d₅₀ values below 25 μm, the pigments, owing to their high specific surface area, are difficult if not impossible to provide with a uniform coating of dark pigments. Nor is there any further increase in IR reflection, since the size of the pigments increasingly reaches that of the incident wavelengths. Above a d₅₀ value of 150 μm, in turn, there is a distinct increase in the tendency towards a metallic sparkle effect. Furthermore, there are many application systems into which it is difficult to incorporate such coarse pigments.

The average thickness of the platelet-shaped metal pigment cores is preferably in a range from 0.25 to 4 μm, more preferably from 0.3 to 3 μm, and very preferably from 0.4 to 2 μm.

Below an average pigment core thickness of 0.25 μm, the specific surface area of the platelet-shaped cores or substrates is too high to allow uniform coating with dark color pigments. At an average thickness of above 4 μm, the metal core is so thick that the fraction of the metal core and hence also the IR reflection capacity in the pigment of the invention is too small for any effective IR reflection capacity to be achieved any longer.

The average pigment thickness can be determined in a customary manner, known to the skilled worker, by counting of the thicknesses in the SEM or by spreading on a water surface.

The platelet-shaped cores or substrates, preferably metallic effect pigments, preferably have specific BET surface areas of approximately 0.2 to approximately 5 m²/g. Metal pigments or metallic effect pigments having a length or width below 3 μm have too high a specific surface area and can no longer be adequately hidingly coated with dark color pigment. Moreover, platelet-shaped cores or substrates of this size no longer provide optimum reflection of the IR radiation, since they are already smaller than the wavelength of the IR light to be reflected. Moreover, as a result of their high specific surface area, these metal pigments or metallic effect pigments can no longer be fully coated with dark pigments or are no longer able fully to incorporate such pigments into a coating, correspondingly. Above a size—i.e., length and/or width—of 250 μm, the specific hiding achieved by the pigments in terms of the IR-reflecting metal component, and hence the IR reflection, in a paint or an ink, for example, is too low. Moreover, pigments with sizes of more than 250 μm are already very clearly perceptible to the eye as particles, and this is undesirable.

The platelet-shaped metallic cores or substrates, or metal pigments, may be present in a form in which they have already been passivated. Examples of such forms are SiO₂-coated aluminum pigments (Hydrolan®, PCX or PCS, Eckart) or chromated aluminum pigments (Hydrolux®, Eckart). When passivated or corrosive-protected substrates of this kind are used, maximum stabilities are provided in terms of the gassing stability in an aqueous paint, more particular an emulsion paint, and the same may also hold for the corrosion stabilities in the exterior sector.

The coating which substantially envelops the platelet-shaped core and whose absorption for IR radiation is substantially low preferably comprises dark color pigments and a matrix.

In such a coating, the dark color pigments may be disposed in, on and/or under the matrix. In any case, the dark color pigments are fixed through the matrix or in the matrix on the platelet-shaped core. The dark color pigments are preferably largely enveloped by the matrix or embedded in the matrix, and are therefore surrounded by it. Alternatively the dark color pigments may be disposed on the matrix and may be fixed with the matrix on the pigment surface via electrostatic forces, for example.

In accordance with one preferred version, the matrix, together with the dark color pigments, envelops the platelet-shaped metal core, preferably uniformly. This preferably enveloping matrix also protects the core from the corrosive effect of water or atmospheric gases.

A substantially enveloping coating for the purposes of the invention means that the IR-reflecting, platelet-shaped core is enveloped by the coating in such a way that, to a viewer, the core does not evoke any perceptible lustrous impression. Moreover, the degree of envelopment is so large that, in the case of a corrosion-susceptible metallic IR-reflecting core, as in the case of aluminum flakes, for example, the incidence of corrosion is suppressed or prevented.

As a result of the uniform coating of the IR-reflecting core with color pigments which are hiding and absorbing in the optical wavelength range but which are largely dark and whose IR absorption is low, the pigment of the invention overall acquires a largely dark appearance. The optical effect originating from the IR-reflecting core is largely suppressed and preferably completely suppressed. Owing to the low level of IR absorption of the applied dark color pigments, surprisingly, a high IR reflectance is obtained for the pigment of the invention.

In the context of this invention, “optical properties” or “optical effect” are always those properties of the IR radiation-reflecting pigments that are visible to the human eye. Physically, these properties are determined substantially by the optical properties in the wavelength range from approximately 400 to approximately 800 nm.

By dark in this context is meant that the pigments of the invention absorb large regions of visible light and hence appear dark to a human viewer.

Dark color pigments whose absorption for IR radiation is low are pigments which have a substantially low absorption in the IR spectral range, and hence have substantially an IR transparency and/or an IR reflection capacity. Preferred dark color pigments, preferably in the form of particles, are those which have low levels of absorption in the wavelength range of the NIR spectral range (0.8 to 2.5 μm) and hence are low-absorbing for NIR.

In one preferred embodiment the dark, preferably black and/or brown, color pigments whose absorption in the IR range is low are particles having an average primary particle size of 10 nm to 1000 nm, preferably of 20 to 800 nm, more preferably of 30 nm to 400 nm.

Below an average primary particle size of 10 nm, the dark color pigments are too fine to be able to be applied uniformly to the metal pigment substrate surface, so that the decorative effects of the metallic core (gloss, flop, etc.) are effectively suppressed. Above 100 nm the specific hiding and hence the effect of the dark pigments is too small, and so, again, the optical properties of the metallic core are manifested too strongly.

The dark color pigments may be selected, for example, from the group of complex inorganic chromatic pigments such as spinel mixed phases, iron oxides, iron-manganese mixed oxides. The mixed-phase pigments are preferably copper-chromium spinels of the type CuCr₂O₄, chromium iron black Cr₂O₃(Fe), chromium iron brown (Fe,Cr)₂O₃ and/or (Zn,Fe)(Fe,Cr)₂O₄. Alternatively they may be dark organic color pigments from the group of the perylenes, such as Paliogen black or Lumogen (BASF, Germany), for example, or may be composed of mixtures of all of the pigments exemplified here.

The absorption capacity of the dark color pigments in the IR range is preferably low; color pigments of this kind are also referred to as “cold-IR” pigments.

Particular preference is given to using spinel mixed-phase pigments or perylenes of the kind sold, for example, by the companies Ferro, USA, and Shepherd, USA, or BASF, Germany. The spinel mixed-phase pigments in particular have the advantage of very high chemical and thermal stabilities.

The amount of dark color pigment used that is incorporated into or applied to the coating is dependent on the nature, the size, and, in particular, the specific surface area of the IR-reflecting, platelet-shaped, metallic core. The specific surface area of the IR-reflecting core means the surface area of the IR-reflecting core per unit weight. The specific surface area of the IR-reflecting core is determined using the known BET method.

In order to ensure sufficiently great dark masking in the case of the IR-reflecting pigments of the invention, they preferably contain dark color pigments in an amount of 20% to 80% by weight, more preferably of 30% to 70% by weight, and with particular preference of 40% to 65% by weight, based in each case on the weight of the total IR-reflecting pigment of the invention.

At amounts of below 20% by weight of dark color pigments, the desired dark masking of the IR-reflecting pigments may be too low, as a result of which the IR-reflecting pigments may have a metallic effect, which is undesirable. At amounts of more than 80% by weight, the IR reflection may be inadequate, since the fraction of the IR-reflecting core may be too low based on the total pigment. In order to obtain good IR reflection in an ink or paint, for example, with the latter pigments, this medium must be given correspondingly high pigmentation. High pigmentation, i.e., a high inventive pigment content in the application medium, leads on the one hand to high production costs. On the other hand there may also be instances of overpigmentation and hence poor performance properties on the part of the ink or paint.

In other preferred embodiments, per 1 m² of surface area of the platelet-shaped, IR-reflecting metal core, it is preferred to apply 0.3 to 10 g, preferably 0.5 to 7 g, more preferably 0.7 to 3 g, and very preferably 1.0 to 2.5 g of the dark pigment to the preferably platelet-shaped metal pigment or to the platelet-shaped metallic core.

Below 0.3 g/m² of substrate surface, the degree of coverage of the preferably platelet-shaped metal pigment with the dark color pigment or pigments may be too low to provide a satisfactory dark effect. Above 10 g/m², the dark effect is virtually saturated and the fraction of the IR-reflecting core as a proportion of the total pigment may be too low, with the consequence that a pigment of the invention of this kind may no longer have sufficient IR reflection capacity.

Sunlight reaching the surface of the Earth as radiation can be divided, as already mentioned in the introduction, into three subranges: 3% of the energy reaching the surface covers the UV spectral range (295-400 nm), almost 50% the visible range (400-800 nm), and 47% the IR range (800-2500 nm).

Since dark materials in particular as a general rule absorb the UV and visible ranges almost completely, it is possible in theory for a black material which reflects IR radiation completely to reflect not more than 47% of the solar radiation.

The reflection capacity of materials for solar radiation can be determined by means of the ASTM standard E903. The solar reflectance here is determined from a reflectance measured against a gold standard, over the wavelength range 300 to 2500 nm, weighted via the spectral intensity distribution of solar radiation.

Along the lines of the ASTM standard E903, the procedure adopted for the pigments of the invention was as follows:

On the assumption that substantially dark or black pigments absorb the radiation virtually completely in the UV-Vis spectral range (295-800 nm), the UV/Vis range (295-800 nm) is disregarded and a solar NIR reflectance ρ_{NIR(solar)}(λ) (see equation 1) is defined for the wavelength range 800-2500 nm. Said reflectance is the product of an ascertained NIR reflectance ρ_{NIR}(λ) (see equation 2), weighted by the fraction of the spectral intensity distribution of the solar radiation in the NIR range E_{NIR}(λ) (800-2500 nm).

$$\begin{matrix}{ρ}_{NIRsolar} ( T ) = \frac{{\int }_{0.8}^{2.5} {ρ}_{NIR} ( λ ) * {E}_{NIR} ( λ ) * d λ}{{\int }_{0.8}^{2.5} {E}_{NIR} ( λ ) * d λ} where & ( 1 ) \\ {ρ}_{NIR} ( λ ) = \frac{NIR reflectance of sample against black standard ( λ )}{NIR reflectance of gold against black standard ( λ )} & ( 2 )\end{matrix}$$

Related to an example, this means that, for example, a sample having a here-defined solar NIR reflectance ρ_{NIR(solar)}(λ) of 36% is able to reflect 36% of the solar NIR radiation in the range of 800-2500 nm that is incident on the Earth. On the assumption that virtually no fraction is reflected by black pigments in the UV/Vis spectral range, 36% of the proportionally 47% from the NIR range of the solar radiation would be reflected, i.e., around 17% of the total solar radiation could be reflected.

The reflection capacity of the pigments of the invention in applications can be determined as follows: using an MPA-R FT-NIR spectrometer from Bruker, and by means of an Ulbricht integrating sphere (gold surface), the diffuse reflection can be measured over all spatial angles. For this purpose a gold standard with a roughened surface is measured against an absolute black standard. A sample is measured against the black standard and then relativized against the values of the gold sample. This produces a corresponding reflectance for each wavelength in the NIR range (800-2500 nm) (standardized in percentage terms to the maximum reflection of the gold standard), which in accordance with equation (1) is given a wavelength-dependent weighting against the solar radiation.

In opaque paint applications in accordance with the above determination, the pigments of the invention have a solar NIR reflectance ρ_{NIR(solar)}(λ) of at least 15% at 298 K. With further preference, the IR radiation-reflecting pigments have a reflectance of more than 25%, and very preferably of more than 30%. This means, in the case of a solar NIR reflectance of 30%, that 30% of the NIR fraction of the solar radiation in the range from 800 to 2500 nm is reflected.

In order more closely to characterize the absorption of the substantially, preferably completely, enveloping coating whose absorption is substantially low, and which preferably has no absorption, it is possible to determine the above-described NIR absorptance α_{NIR(solar)}(λ)_{coating} of a coated pigment of the invention from the solar reflectances, as follows (equation 3):

$${{α}_{NIR ( solar )} ( λ )}_{coating} = 1 - \frac{{{ρ}_{NIR ( solar )} ( λ )}_{coated pigment}}{{{ρ}_{NIR ( solar )} ( λ )}_{uncoated metal pigment}} \qquad ( 3 )$$

The value α_{NIR(solar)}(λ)_{coating} defined in accordance with equation 3 is identified for the purposes of this invention as “NIR absorptance, coating”. The calculated ratio is preferably <0.6, preferably <0.3, and more preferably <0.2. The lower the absorptance of the coating, the less the extent to which the optimum NIR reflection of the uncoated metal core is diminished by the coating.

A substantially or largely transparent and substantially, preferably completely, enveloping coating is a reference to coatings in which the IR radiation-reflecting pigment of the invention exhibits the properties identified above in respect of its IR reflectance. The enveloping coating which has low absorption substantially or largely in the NIR preferably contains dark color pigments which evoke or enhance the dark appearance.

The dark color pigments used may also be surface-treated and may be coated, for example, with metal oxides and/or modified by surface-active substances such as dispersants, surfactants, and organic polymers, or may be present together with these. In particular the dark color pigments may be enveloped or encapsulated by metal oxide(s), such as SiO₂, for example.

The pigments of the invention preferably possess a significant reflection capacity in the spectral IR range from 800 nm up to an upper limit of 1500 nm, more preferably up to 2500 nm, more preferably still up to 15 000 nm and with particular preference up to 25 000 nm.

The wavelength range in the NIR range of 800-1500 nm and of 800-2500 nm is critical with regard to the thermal heating of objects.

This range is the relatively high-energy component of the thermal radiation, in which the irradiated solar radiation is relatively high, and which can be correlated with thermal heating.

In order to illustrate this, the solar NIR reflectances calculated here for the pigments set out in the examples (cf. table 1 and FIG. 1) have been correlated with the resulting surface temperatures of painted ABS panels (after 30 minutes of irradiation with a 500 W lamp) and plotted in FIG. 1.

Corresponding NIR reflection spectral curves of the pigments reported in the examples are indicated, in the form of spray-paint applications on black ABS panels, in FIGS. 2 and 3.

High reflectances over the entire IR range, i.e., from 800 nm to 15 000 nm or to 25 000 nm, are of particular interest for IR camouflage paints in particular.

The pigments of the invention exhibit not only a high reflection capacity in the NIR range (cf. FIGS. 2 and 3, measured as paint application on black ABS panels) but also significant reflectances in the MIR range (cf. FIGS. 4 and 5, measured as a 1.5% powder bed in KBr).

A characteristic of effect pigments in particular is the high gloss of an ink or paint coating comprising the effect pigments. Since the pigments of the invention no longer display these characteristic optical gloss properties of the effect pigments, the paint drawdowns possess very low gloss values.

The criterion employed here is the gloss at 60° as measured in accordance with the manufacturer's instructions using a Trigloss instrument from Byk-Gardner, Germany. In a correspondingly pigmented and hidingly applied NC varnish drawdown, the pigments of the invention possess a gloss of 0.1 to 2, preferably of 0.2 to 1, units. Customarily the gloss of effect pigments is in a range from about 30 to 160, which shows that the metallic luster which is typical of metallic effect pigments is effectively suppressed in the case of the pigments of the invention.

The matrix of the coating whose absorption for IR radiation is substantially low, and which largely, preferably completely, envelops not only the core but also the dark pigments, is optically far-reaching. The matrix comprises or preferably consists of metal oxides and/or one or more organic polymers and/or binder(s). The dark pigments may also be applied on the substantially, preferably completely, enveloping coating or matrix. The matrix is preferably largely colorless, in order not to detract from the visual effect produced by the applied or incorporated dark color pigments.

By largely colorless is meant in accordance with the invention that the metal oxides and/or organic polymers and/or binders do not have any substantial intrinsic coloration that cannot be covered over by the color effect generated by the dark color pigments.

If the core is composed of a platelet-shaped metal pigment, then the largely colorless matrix material is preferably a metal oxide, since in this way the core can be protected very effectively against corrosion. The metal oxide to be used for the matrix material, and also the amount thereof, are selected in particular from the standpoint that the pigment of the invention absorbs IR radiation to as small an extent as possible. Any IR absorption on the part of the pigments of the invention results in reduced IR reflection and hence attenuates the desired effect of the pigments of the invention. An effect of the matrix material is to cause the color pigments to adhere to the IR radiation-reflecting core, and so the dark color pigments, even after their dispersion into the application medium, remain largely adhering to the IR radiation-reflecting core. It is this reliable attachment that in fact makes it possible for the optical phenomena that are typical of effect pigments to be suppressed, and for the largely dark appearance to be obtained, which is not achievable as a result of pure blending of metallic effect pigment and dark color pigment. Furthermore, the reliable coupling of dark color pigment and IR radiation-reflecting pigment rules out their separation, thereby reliably suppressing the effects typical of a metallic effect, such as gloss, sparkle and/or flop.

Examples of very suitable metal oxides are silicon dioxide and/or partially hydrated silicon dioxide, aluminum oxide, aluminum hydroxide, boron oxide, boron hydroxide, zirconium oxide or mixtures thereof. Particular preference is given to silicon dioxide.

In other preferred embodiments, one or more organic polymers and/or binders are used as matrix material. Particular preference in this case is given to those polymers which are also used as binders in varnishes, paints or printing inks. Examples thereof are polyurethanes, polyesters, polyacrylates and/or polymethacrylates. It has been found that the pigments of the invention can be incorporated very well into binders if the organic coating and the binder are very similar to one another or identical.

The binders also preferably have a glass transition temperature of above 75° C. and more preferably of above 90° C. As a result, the matrix has a solidity at room temperature which is such that there is no detachment of dark color pigments present in the matrix.

The optically largely colorless matrix is present preferably in a fraction of 2% to 30% by weight, based on the weight of the total pigment. The fraction is preferably 5% to 20% by weight and more preferably 6% to 15% by weight.

Surprisingly, with such small amounts of matrix material, it is possible not only for the dark color pigments to be disposed reliably and uniformly on the surface of the platelet-shaped cores, but also, in the case of metallic cores, for these cores to be made stable to corrosion. In the case of a fraction below 2% by weight it may be the case that the pigments are not disposed with sufficient reliability on the surface of the IR-reflecting core. It may also be the case, furthermore, that, in the case of metallic cores, the required corrosion stability, which necessitates near-complete envelopment of the cores by the matrix, is not sufficiently present at these small amounts. With amounts of more than 30% by weight, it may be the case that the matrix material adversely increases the IR absorption and thus severely diminishes the IR reflectance.

In accordance with one preferred development of the invention, the IR radiation-reflecting core is a platelet-shaped metal pigment, the metal being selected preferably from the group consisting of aluminum, copper, zinc, iron, silver, and alloys thereof.

In one particularly preferred embodiment the IR-reflecting core is composed of platelet-shaped aluminum and the optically largely colorless matrix is composed of SiO₂. It is further preferred for the dark color pigment to be selected from the group of complex inorganic chromatic pigments such as spinel mixed phases, iron oxides, iron-manganese mixed oxides, and mixtures thereof. The mixed-phase pigments are preferably copper-chromium spinels of the type CuCr₂O₄, chromium iron black Cr₂O₃(Fe), chromium iron brown (Fe,Cr)₂O₃ and/or (Zn,Fe)(Fe,Cr)₂O₄.

Aluminum possesses the highest IR reflection and is very readily available commercially. SiO₂ is outstandingly suitable for providing the aluminum with corrosion stability. The dark color pigments from the series of complex inorganic chromatic pigments, moreover, are distinguished by properties of low NIR absorption, and possess a high chemical and thermal stability.

In accordance with another preferred embodiment, the pigments of the invention have an organic surface modification. The pigments of the invention are preferably modified with leafing promoters. The effect of the leafing promoters is to cause the pigments of the invention to float at the surface of the application medium, an ink, for example, preferably an emulsion paint or a varnish. As a result of the disposition of the pigments of the invention at the surface of the application medium, the IR reflection capacity in the applied state is enhanced, since the IR radiation is reflected even at the surface of the application medium and does not have first to penetrate the application medium, as a result of which there may be absorption losses.

Preferably the pigments of the invention are surface-modified with long-chain saturated fatty acids such as, for example, stearic acid, or palmitic acid, or long-chain alkylsilanes having 8 to 30 C atoms, preferably 12 to 24 C atoms, or with long-chain phosphoric acids or phosphonic acids or their esters and/or long-chain amines.

In the method of the invention for producing the dark, IR-reflecting pigments of the invention, a dark coating whose absorption for IR radiation is substantially low is applied to a platelet-shaped, metallic, IR radiation-reflecting core.

For example, the platelet-shaped cores can be suspended in a corresponding coating solution which comprises, for example, dark color pigments and also the components for forming a matrix, in a suitable solvent, and may thus be coated.

The coating preferably comprises dark color pigments and a matrix.

In order to avoid repetition, reference is made, in relation to the pigment of the invention produced by the methods of the invention, to the elucidations above, which apply correspondingly to the method of the invention.

In the case of a further-preferred variant of the method, the dark color pigments whose absorption for IR radiation is substantially low are applied together with metal oxide, using wet-chemical sol-gel processes, in an enveloping manner, preferably completely, around the core, by means of precipitation, for example, and so the dark color pigments are embedded substantially in the metal oxide layer.

In this case it is particularly preferred to apply SiO₂ as the metal oxide to the IR-reflecting, platelet-shaped core using a wet-chemical sol-gel process, with hydrolysis of tetraalkoxysilanes, for example.

In another preferred variant of the method, the method of the invention comprises the following steps:
a) dispersing the platelet-shaped, IR-reflecting pigment core in a solvent, preferably in an organic solvent,
b) adding water, a metal alkoxy compound, and, optionally, a catalyst, with optional heating in order to accelerate the reaction,
c) adding IR-transparent dark color pigments, preferably in the form of a dispersion in a solvent, preferably in organic solvent.

After the end of reaction, the pigment of the invention, i.e., the platelet-shaped, IR-reflecting platelet-shaped core coated with dark pigments and metal oxide, can be separated from unreacted starting materials and from the solvent. This may be followed by drying and, optionally, by size classification.

As a metal alkoxy compound it is preferred to use tetraalkoxysilanes such as tetramethoxysilane or tetraethoxysilane in order to precipitate an SiO₂ layer preferably having dark color pigments embedded therein onto the core and preferably enveloping the core.

Organic solvents used are preferably water-miscible solvents. Particular preference is given to using alcohols such as, for example, methanol, ethanol, n-propanol, isopropanol, n-butanol, isobutanol, tert-butanol or glycols.

The amount of water ought preferably to be between 1.5 times and 30 times the amount needed stoichiometrically for the sol-gel reaction. The amount of water is preferably between 2 times and 10 times the stoichiometrically required amount.

Below 1.5 times the stoichiometrically required amount, the reaction rate of the sol-gel process is too slow, and above 30 times the stoichiometrically required amount the formation of layers may not be sufficiently uniform.

The reaction temperature during the sol-gel reaction is preferably between 40° C. and the boiling temperature of the solvent used.

Catalysts which can be used in the sol-gel reaction include weak acids or bases.

Acids used are preferably organic acids such as, for example, acetic acid, oxalic acid, formic acid, etc.

Bases used are preferably amines. Examples thereof are as follows: ammonia, hydrazine, methylamine, ethyl-amine, triethanolamine, dimethylamine, diethylamine, methylethylamine, trimethylamine, triethylamine, ethylenediamine, trimethylenediamine, tetramethylene-diamine, 1-propylamine, 2-propylamine, 1-butylamine, 2-butylamine, 1-propylmethylamine, 2-propylmethylamine, 1-butylmethylamine, 2-butylmethylamine, 1-propylethyl-amine, 2-propylethylamine, 1-butylethylamine, 2-butyl-ethylamine, piperazine and/or pyridine.

The dark color pigments can be comminuted mechanically, preferably prior to their addition to the coating suspension, in order to have as many primary particles present as possible. This can be done conventionally in an organic solvent, where appropriate with addition of suitable dispersing additives and/or binders. Comminution may take place in the customary assemblies, such as a triple-roll mill, co-ball mill, toothed wheel dispersing mill, etc., for example.

In another embodiment of the method of the invention the pigments of the invention are produced by a spray-drying process.

In the case of this variant of the method, a dispersion, comprising a volatile organic solvent, IR radiation-reflecting, platelet-shaped cores, dark color pigments, and one or more organic polymers and/or binders is spray-dried with spraying.

The spray drying is carried out preferably in an agitated atmosphere, such as a fluidized bed, for example, in order to prevent agglomeration. In the course of spray drying, the platelet-shaped cores are coated uniformly with the organic, preferably film-forming, polymer and/or binder and with the dark color pigments. After drying, the organic, preferably film-forming polymer and/or binder may be cured. This can be done preferably likewise in the spray drying apparatus, by making the temperature of the feed gas above the curing temperature of the binder, for example.

In another embodiment of the method of the invention, the preferably platelet-shaped pigment of the invention that reflects IR radiation may be obtained by coating the IR-reflecting cores with a matrix of suitable starting compounds and dark color pigments in a fluidized-bed method.

The IR radiation-reflecting, preferably platelet-shaped, pigments of the invention are used preferably in paints, varnishes, printing inks, security inks, textiles, military applications or plastics.

Application media pigmented with the pigments of the invention, such as paints or varnishes, for example, possess a largely dark appearance. The degree of darkness of these application media may be increased further where appropriate by means of further addition of color pigments, possibly IR-transparent, examples being Paliogen black or Lumogen (BASF). Moreover, different-colored paints or varnishes can be produced by tinting with colorants such as organic or inorganic color pigments.

In order to minimize the IR absorptance of a wall coated, for example, with an emulsion paint, it is preferred for the emulsion paint to comprise the pigments of the invention in an amount such that the fraction of the IR radiation-reflecting cores, based on the weight of all nonvolatile components of the emulsion paint, is 2% to 30% by weight, preferably 4% to 20% by weight, and more preferably 7% to 15% by weight.

In order to be able to realize minimal absorptances and maximum reflectances, it is preferred for the further components of the application medium, such as binders or fillers, for example, likewise to have a minimal IR absorption. The levels of pigmentation of the binders, fillers and/or dark color pigments can also be much lower than is usual in the prior art, as a result of the additional pigmentation provided by the pigments of the invention.

The following examples and figures serve to elucidate the invention, without restricting it in any way whatsoever.

### FIGURES

FIG. 1 shows the correlation of thermal heating of painted ABS polymer panels after 30 minutes of irradiation with a 500 W lamp as a function of calculated solar reflectances.

### (Dashed Line: Compensation Line)

FIG. 2 shows NIR reflection spectra of pigments of inventive example 1 in comparison to comparative examples 3 and 8 and also 7.

FIG. 3 shows NIR reflection spectra of pigments of inventive example 2 in comparison to comparative examples 4 and 8 and also 7.

FIG. 4 shows MIR reflection spectra of pigments of inventive example 1 in comparison to comparative examples 3 and 9.

FIG. 5 shows MIR reflection spectra of pigments of inventive example 2 in comparison to comparative examples 4 and 9.

### EXAMPLE 1 IN ACCORDANCE WITH THE INVENTION

In 250 g of isopropanol, 77 g of aluminum pigment paste Metallux 212 (65% form, Eckart) were dispersed with stirring, 5 g of tetraethoxysilane were added, and the mixture was heated under reflux. Subsequently 0.50 g of ethylenediamine (EDA) in 15 of fully demineralized water was and the mixture was heated under reflux for 50 minutes. This was followed by a further addition of 0.40 g of EDA of 10 g of isopropanol. After a further 10 minutes of reaction time, a dispersion of 37.5 g of the dark color pigment Shepherd 20C980 (Shepherd, USA) with 30 g of tetraethoxysilane was metered in continuously over 2 hours, with the addition of 0.50 g of EDA in 10 g of isopropanol after 30 minutes, after 60 minutes, and after 90 minutes. Following the final addition, the reaction mixture was allowed to cool and stirred at 20° C. for a further 16 hours. The reaction mixture was filtered and the product was washed with isopropanol, the resulting pigment being dried under reduced pressure at 100° C.

The quantity of dried pigment obtained was dispersed in 250 g of isopropanol, and the stated procedure was repeated again with 37.5 g of the color pigment Shepherd 20C980.

The reaction mixture was filtered and the product was washed with isopropanol, the resulting pigment being dried under reduced pressure at 100° C.

For the measurement of the NIR reflection spectra (wavelength range 0.8 to 2.5 μm), the resulting pigment was incorporated in 12% form into a melamine-based varnish and painted hidingly by means of spray application onto black ABS polymer panels (15×10 cm).

NIR reflection measurements were carried out on the painted specimen using an MPA-R FT-NIR spectrometer from Bruker, and by means of an Ulbricht integrating sphere (gold surface), in accordance with the manufacturer's instructions. The data obtained were referenced against a gold standard and standardized.

Spectral data obtained are depicted in FIG. 2. The solar NIR reflectance was calculated in accordance with equation 1 from the NIR spectral data obtained (table 1).

For the recording of NIR reflection measurement (wavelength range 2.5 to 25 μm), measurement took place in diffuse reflection from a 1.5% powder bed in KBr.

For this purpose, finely mortared KBr was combined homogeneously with pigment, and a tablet-shaped sample chamber (diameter: 0.8 cm, depth: 2.2 mm) was filled with the mixture and subjected to pressure. By means of a Selector measuring unit (Specac), the IR reflection spectrum was measured in a quarter geometry (as IR instrument Avatec 360 from Thermo with DTGS detector). As a reference, measurement was carried out against pure KBr. The spectral curve is depicted in FIG. 4.

For determining temperature heating, the painted ABS panel was irradiated with a commercial 500 W lamp for 30 minutes at a distance of 35 cm and the surface temperature was determined using a surface thermometer. The data obtained are set out in table 1 and in figure are correlated with the calculated solar NIR reflectance.

Furthermore, a nitrocellulose drawdown (20% form, 100 μm wet film thickness) of the resulting pigment was prepared.

Angle-dependent color measurements on the drawdown (M 682 instrument from X-Rite) were used to determine L*, a*, b*, C* and h*; L*, a*, b*, C*, and h* were determined via diffuse colorimetry (Minolta CR-410) over all spatial angles; and gloss values were determined at 60° and 85° (Trigloss instrument, Byk-Gardner).

The values obtained are reported in table 2.

### EXAMPLE 2 IN ACCORDANCE WITH THE INVENTION

In analogy to inventive example 1, the dark color pigment Shepherd 10C909A was used to coat the aluminum pigment, using the same method.

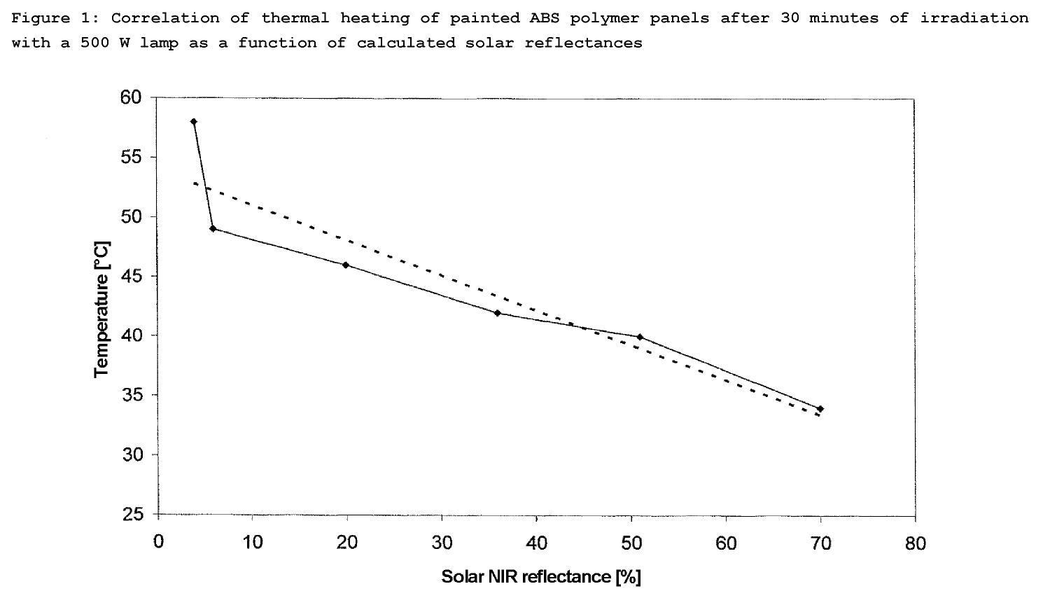

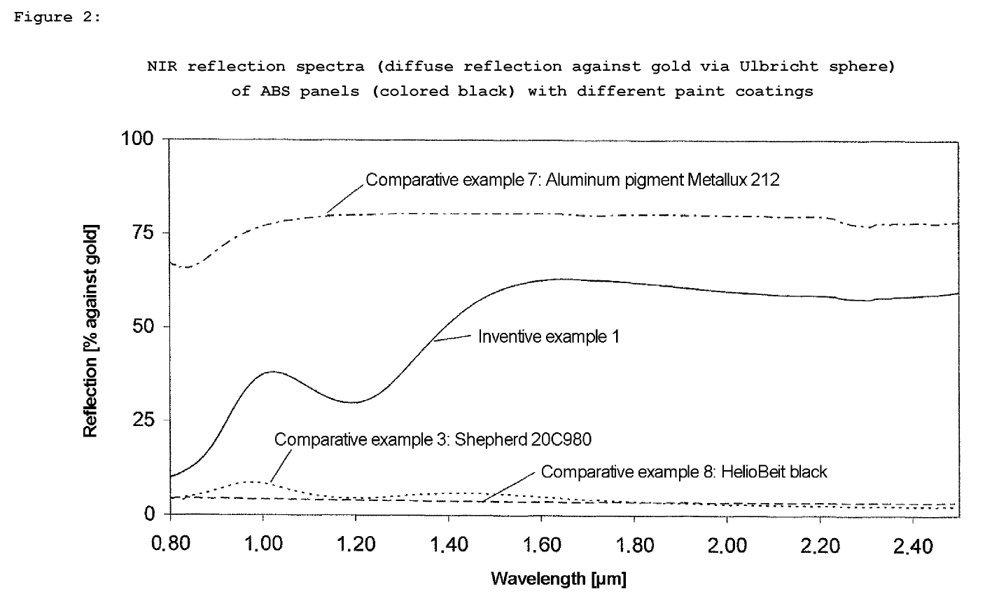

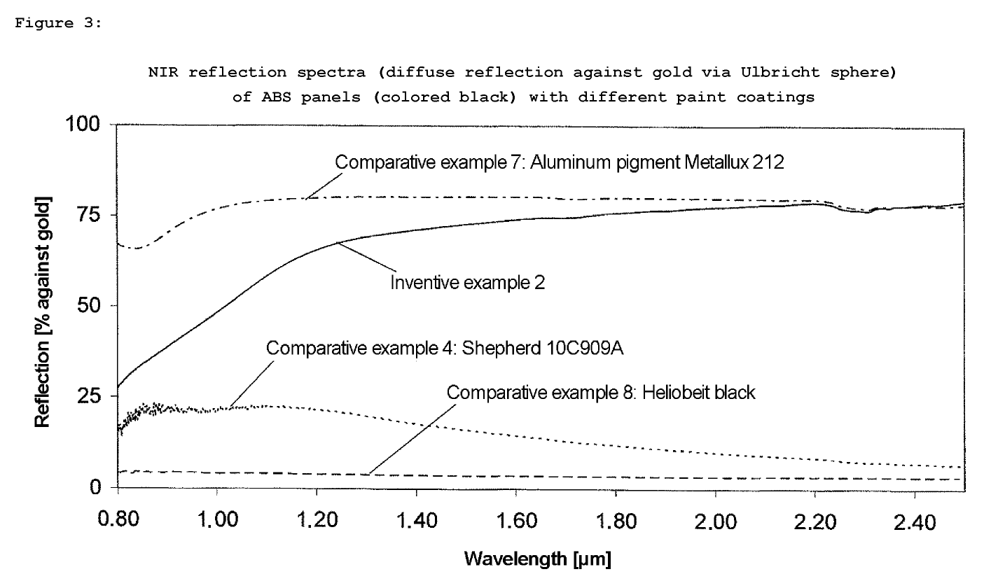

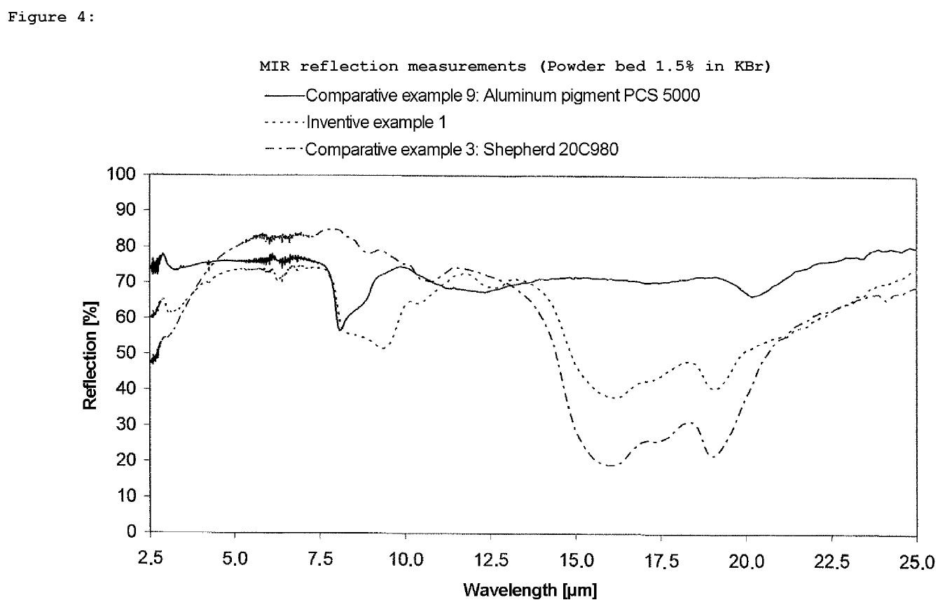

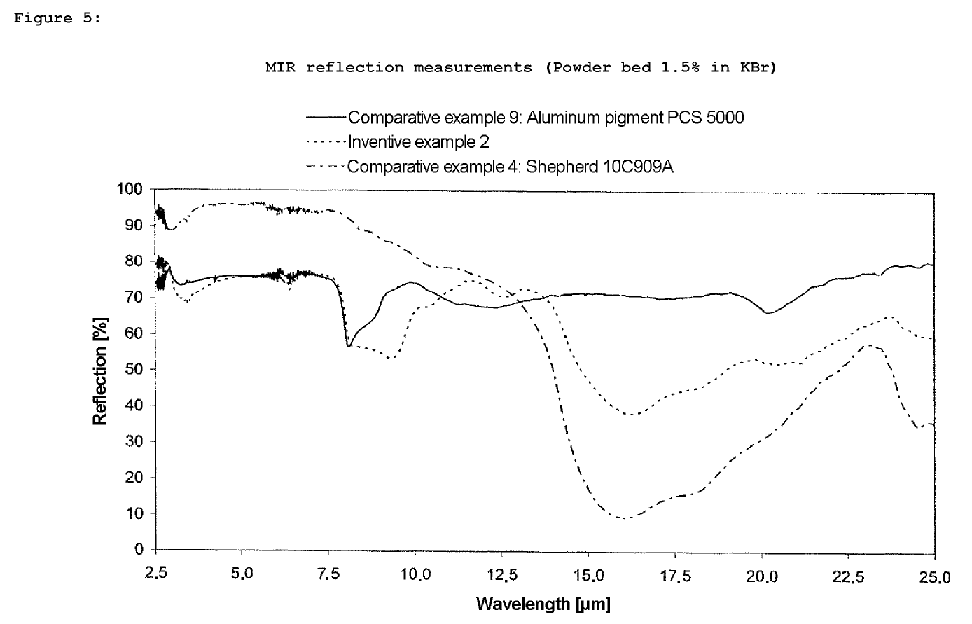

For the determination of the NIR and MIR spectral data, of the solar NIR reflectance, and for color measurements and gloss measurements, the procedure adopted was like that of example 1 (FIGS. 1, 3, and 5, tables 1 and 2).

### COMPARATIVE EXAMPLE 3

As a comparative example, the pigment Shepherd 20C980 was used in the application media (spray-paint application: 6% in melamine-based varnish on black ABS polymer panel; nitrocellulose varnish drawdown: 12% form, 100 μm wet film thickness). The data of the NIR and MIR spectral measurements, the calculated solar NIR reflectance, color measurements, and gloss measurements were determined in the same way as for example 1 (FIGS. 1, 2, and 4, tables 1 and 2).

### COMPARATIVE EXAMPLE 4

As a comparative example, the pigment Shepherd 10C909A was used in the application media (spray-paint application: 6% in melamine-based varnish on black ABS polymer panel; nitrocellulose varnish drawdown: 12% form, 100 μm wet film thickness). The data of the NIR and MIR spectral measurements, the calculated solar NIR reflectance, color measurements, and gloss measurements were determined in the same way as for example 1 (FIGS. 1, 3, and 5, tables 1 and 2).

### COMPARATIVE EXAMPLE 5

As a comparative example, a mixture of the pigment Shepherd 20C980 with an aluminum pigment STAPA Metallux 212 was incorporated into the application medium of the nitrocellulose varnish drawdown (12% 20C980, 8% Metallux 212, 100 μm wet film thickness).

NIR spectral data were not determined, owing to the inadequate optical properties. The data of the color measurements and gloss measurements were determined in the same way as for example 1 (table 2).

### COMPARATIVE EXAMPLE 6

As a comparative example, a mixture of the pigment Shepherd 10C909A with an aluminum pigment STAPA Metallux 212 was incorporated into the application medium of the nitrocellulose varnish drawdown (12% 10C909A, 8% Metallux 212, 100 μm wet film thickness). NIR spectral data were not determined, owing to the inadequate optical properties. The data of the color measurements and gloss measurements were determined in the same way as for example 1 (table 2).

### COMPARATIVE EXAMPLE 7

As a comparative example, an aluminum pigment STAPA Metallux 212 was incorporated into the application medium of the nitrocellulose varnish drawdown (8% Metallux 212, 100 μm wet film thickness).

The data of the NIR spectral measurements, the solar NIR reflectance, color measurements and gloss measurements were determined in the same way as for example 1 (FIGS. 1, 2, and 3, tables 1 and 2).

### COMPARATIVE EXAMPLE 8

As a comparative example, the carbon black pigment HelioBeit black was used in the application media (spray-paint application: 20% melamine-based varnish on black ABS polymer panel). The data of the NIR spectral measurements and the calculated solar NIR reflectance were determined in the same way as for example (FIGS. 1, 2, and 3, and table 1).

### COMPARATIVE EXAMPLE 9

As a comparative example, for the recording of the MIR reflection spectrum, an SiO₂-encapsulated aluminum pigment PCS 5000 (Eckart) was subjected to the same procedure as in example 1 (FIGS. 4 and 5).

TABLE 1
Calculated solar NIR reflectances and temperature measurement
after 30 minutes of irradiation with a 500 W lamp

| | | | Temperature |
|---|---|---|---|
| | Pigmentation | | after 30 min. |
| | in | | irradiation |
| | melamine- | Calculated | with |
| | based | solar NIR | 300 W lamp |
| Pigment | varnish | reflectance [%] | [° C.] |
| Example 1 | 12% | 36 | 42 |
| Example 2 | 12% | 51 | 40 |
| Comparative example 3 | 6% form | 6 | 49 |
| (20C980) | | | |
| Comparative example 4 | 6% form | 20 | 46 |
| (10C909A) | | | |
| Comparative example 5 | — | not determined* | not |
| (Mixture 3/7) | | | determined* |
| Comparative example 6 | — | not determined* | not |
| (Mixture 4/7) | | | determined* |
| Comparative example 7 | 6% form | 70 | 34 |
| (Aluminum pigment | | | |
| Metallux 212) | | | |
| Comparative example 8 | 20% | 4 | 59 |
| (HelioBeit black) | | | |

*Owing to inadequate optical appearance

TABLE 2
Overview of color and gloss values of the pigments listed in the examples (applied hidingly in nitrocellulose varnish)

| | | | | | | | | | | | | | | Gloss |
|---|---|---|---|---|---|---|---|---|---|---|---|---|---|---|
| | | | Angle-dependent | | | | | DuPont | Diffuse | | | | | values |
| | | | color measurement | | | | | flop | color measurement | | | | | Gloss |
| Pigment | Paint | Angle | L* | a* | b* | C* | h* | index | L* | a* | b* | C* | h* | 60° |
| Example 1 | 20% | 15 | 30.6 | 0.4 | 0.1 | 0.4 | 19.7 | 0.08 | 28.62 | 0.03 | −0.78 | 0.75 | 269.64 | 0.5 |
| | in NC | 25 | 29.2 | 0.2 | −0.3 | 0.4 | 299.3 | | | | | | | |
| | | 45 | 27.6 | −0.1 | −1.0 | 1.0 | 265.3 | | | | | | | |
| | | 75 | 29.5 | −0.3 | −1.9 | 1.9 | 259.7 | | | | | | | |
| | | 110 | 29.8 | −0.4 | −2.4 | 2.4 | 260.3 | | | | | | | |
| Example 2 | 20% | 15 | 36.6 | 5.7 | 6.4 | 8.6 | 48.3 | 0.39 | 33.38 | 6.63 | 5.95 | 8.93 | 42.01 | 0.4 |
| | in NC | 25 | 34.7 | 6.0 | 6.1 | 8.6 | 45.6 | | | | | | | |
| | | 45 | 31.8 | 6.6 | 6.0 | 8.9 | 42.2 | | | | | | | |
| | | 75 | 32.4 | 8.2 | 7.0 | 10.7 | 40.5 | | | | | | | |
| | | 110 | 32.0 | 8.0 | 6.8 | 10.4 | 40.4 | | | | | | | |
| Comparative | 12% | 15 | 40.3 | 0.7 | 0.2 | 0.8 | 16.6 | 2.83 | 24.74 | 0.38 | −1.25 | 1.34 | 286.51 | 4.4 |
| example 3 | in NC | 25 | 32.0 | 0.2 | −1.2 | 1.2 | 280.3 | | | | | | | |
| (20C980) | | 45 | 22.4 | 0.1 | −1.9 | 1.9 | 272.7 | | | | | | | |
| | | 75 | 17.2 | 0.2 | −1.9 | 1.9 | 276.7 | | | | | | | |
| | | 110 | 16.7 | 0.3 | −2.0 | 2.0 | 279.3 | | | | | | | |
| Comparative | 12% | 15 | 37.4 | 1.0 | 0.3 | 1.1 | 17.1 | 2.04 | 26.54 | 1.36 | 0.62 | 1.51 | 23.02 | 0.9 |
| example 4 | in NC | 25 | 33.3 | 1.1 | 0.5 | 1.2 | 26.4 | | | | | | | |
| (10C909A) | | 45 | 26.1 | 1.4 | 0.8 | 1.6 | 30.8 | | | | | | | |
| | | 75 | 19.9 | 2.2 | 1.5 | 2.7 | 34.6 | | | | | | | |
| | | 110 | 17.6 | 2.5 | 1.6 | 3.0 | 32.7 | | | | | | | |
| Comparative | 8%/12% | 15 | 92.0 | −0.8 | −2.0 | 2.1 | 247.8 | 2.70 | 65.04 | −0.75 | −0.87 | 1.14 | 228.71 | 3.5 |
| example 5 | in NC | 25 | 76.8 | −0.9 | −0.8 | 1.2 | 222.3 | | | | | | | |
| (Mixture | | 45 | 55.1 | −0.6 | 0.1 | 0.6 | 172.5 | | | | | | | |
| 3/7) | | 75 | 41.8 | −0.6 | −0.6 | 0.8 | 222.3 | | | | | | | |
| | | 110 | 36.6 | −0.4 | −0.9 | 1.0 | 243.4 | | | | | | | |
| Comparative | 8%/12% | 15 | 101.5 | −0.1 | −1.6 | 1.6 | 267.9 | 4.40 | 64.75 | 0.40 | −0.25 | 0.50 | 324.21 | 4.0 |
| example 6 | in NC | 25 | 78.4 | 0.1 | −0.2 | 0.2 | 301.8 | | | | | | | |
| (Mixture | | 45 | 44.8 | 1.2 | 1.2 | 1.7 | 44.9 | | | | | | | |
| 4/7) | | 75 | 29.6 | 2.6 | 2.6 | 3.7 | 45.1 | | | | | | | |
| | | 110 | 28.3 | 2.7 | 2.6 | 3.8 | 44.3 | | | | | | | |
| Comparative | 8% | 15 | 161.1 | 0.5 | −1.0 | 1.1 | 296.5 | 8.99 | 90.11 | −0.38 | −0.81 | 0.89 | 246.29 | 64.3 |
| example 7 | in NC | 25 | 96.0 | −0.4 | −1.9 | 1.9 | 256.6 | | | | | | | |
| (Metallux | | 45 | 41.1 | −0.4 | −1.4 | 1.5 | 252.4 | | | | | | | |
| 212) | | 75 | 23.4 | −0.4 | −0.7 | 0.8 | 240.6 | | | | | | | |
| | | 110 | 23.8 | −0.5 | −1.0 | 1.2 | 242.0 | | | | | | | |

Pigments of the invention exhibit significant reflections in the IR spectral range, not only for the NIR spectral range, as is evident from FIGS. 2 and 3, but also in the MIR range, as is evident from FIGS. 4 and 5. This can be seen from the curve profiles of the spectra.

Furthermore, from the spectral curves in relation to comparative examples 3, 4, and 8, it is apparent that, in comparison, typical dark pigments exhibit substantially no IR reflections or only slight IR reflections. For further comparison it is possible to use conventional aluminum pigments with metallic luster, of comparative examples 7 and 9, which are known to possess very high reflectances in the IR range. These conventional aluminum pigments, in contrast, have characteristic properties, such as metallic optical appearance and gloss behavior and light/dark behavior, which is not desirable for—for example—military camouflage paints.

From color measurements and gloss measurements (table 2) it is evident that the pigments of the invention no longer have such metallic optical qualities. Thus pigments of the invention, in relation to metal pigments or to mixtures of dark pigments and metal pigments, possess extremely low gloss values, which go hand in hand with a low gloss behavior. Measured L* values (diffuse or angle-dependent, table 2) show that these values are low for the pigments of the invention (examples 1 and 2), which are therefore dark pigments (comparative examples 3, 4, and 8), whose optical properties in combination with the reflection capacity cannot be obtained by means of mixtures (comparative examples 5 and 6). The luminance of mixtures and pure aluminum pigments (comparative example 7) is consistently significantly higher. The pigments of the invention no longer have almost any light/dark flop. Even the pure dark color pigments (comparative examples and 4) have higher light/dark flops. They can therefore not be identified as dark. The optical impression of the pigments of the invention, which are perceived by the viewer has being dark, can be quantified accordingly.

The property of reflecting NIR radiation can be quantified on the basis of the solar NIR degree, defined here, for which the reflectances are weighted, wavelength-dependently, via the wavelength-dependent radiation intensities given off from the sun. The inventive examples 1 and 2, listed in table 2, have solar NIR reflectances of 36% and 51%. This means that these pigments are able to reflect 36% and 51%, respectively, of the NIR radiation emitted by the sun. Other dark pigments (comparative examples 3, 4, and 8) exhibit significantly lower solar NIR reflectances.

FIG. 1 shows that the reflection capacity of pigments in coating applications can be correlated with the solar NIR reflectance. The surface temperature after 30 minutes of irradiation with a 500 W lamp is lower in the case of pigments having relatively high solar reflectances than in the case of pigments having relatively low reflectances. This shows that the significant reflection capacity of the pigments of the invention can be utilized for reducing thermal heating of articles coated with pigments of the invention.

1. An IR radiation-reflecting pigment comprising a platelet-shaped, metallic, IR radiation-reflecting core,
wherein
the IR radiation-reflecting core is provided with a substantially enveloping coating whose absorption of IR radiation is substantially low, and wherein the IR radiation-reflecting pigment is substantially dark.

2. The IR radiation-reflecting pigment of claim 1,
wherein
the coating which substantially envelops the core and whose absorption of IR radiation is substantially low comprises dark color pigments and a matrix.

3. The IR radiation-reflecting pigment of claim 2,
wherein
the dark color pigments are disposed in at least one location selected from in, on and under the matrix of the coating whose absorption of IR radiation is substantially low.

4. The IR radiation-reflecting pigment of claim 2,
wherein
the dark color pigments have an average primary particle size of 10 to 1000 nm.

5. The IR radiation-reflecting pigment of claim 2,
wherein
the dark color pigments are selected from the group consisting of spinel mixed phases, iron oxides, iron-manganese mixed oxides, perylenes, and mixtures thereof.

6. The IR radiation-reflecting pigment of claim 2,
wherein
the dark color pigments are present in an amount of 20% to 80% by weight, based on the weight of the total IR radiation-reflecting pigment.

7. The IR radiation-reflecting pigment of claim 2,
wherein
the dark color pigments are disposed substantially uniformly around the IR radiation-reflecting core.

8. The IR radiation-reflecting pigment of claim 1,
wherein
the coating whose absorption of IR radiation is substantially low comprises metal oxide.

9. The IR radiation-reflecting pigment of claim 8,
wherein
the metal oxide is selected from the group consisting of silicon dioxide, aluminum oxide, aluminum hydroxide, boron oxide, boron hydroxide, zirconium oxide, and mixtures thereof.

10. The IR radiation-reflecting pigment of any of claim 1,
wherein
the coating whose absorption of IR radiation is substantially low comprises at least one selected from at least one of organic polymers and binders.

11. The IR radiation-reflecting pigment of claim 10,
wherein
the at least one of organic polymers and binders has a glass transition temperature of above 75° C.

12. The IR radiation-reflecting pigment of claim 1,
wherein
the matrix is present in a fraction of 2% to 30% by weight, based on the weight of the total IR radiation-reflecting pigment.

13. The IR radiation-reflecting pigment of claim 1,
wherein
the IR radiation-reflecting core is a platelet-shaped metal pigment.

14. The IR radiation-reflecting pigment of claim 1,
wherein
the IR radiation-reflecting core is a platelet-shaped metal pigment having a size in a range from 3 to 250 μm.

15. The IR radiation-reflecting pigment of claim 1,
wherein
the IR-reflecting core is a platelet-shaped metal pigment having a d₅₀ value of the cumulative undersize distribution in a range from 25 to 150 μm.

16. The IR radiation-reflecting pigment of claim 1,
wherein
the IR-reflecting core is a platelet-shaped metal pigment having an average thickness in a range from 0.25 to 4 μm.

17. The IR radiation-reflecting pigment of claim 1,
wherein
the IR-reflecting core is a platelet-shaped aluminum pigment.

18. The IR radiation-reflecting pigment of claim 1,
wherein
the IR-reflecting core is a platelet-shaped aluminum pigment, the coating whose absorption of IR radiation is substantially low comprises SiO₂, and the dark color pigment embedded into the coating is selected from the group of complex inorganic chromatic pigments.

19. A method of producing an IR radiation-reflecting pigment of claim 1,
wherein
a platelet-shaped, metallic, IR radiation-reflecting core is enveloped with a dark coating whose absorption for IR radiation is substantially low.

20. The method of producing an IR radiation-reflecting pigment of claim 19,
wherein
the coating comprises dark color pigments and a matrix.

21. The method of producing an IR radiation-reflecting pigment of claim 20,
wherein
the dark color pigments are applied together with metal oxide, using a wet-chemical sol-gel process, in a substantially enveloping fashion around the IR radiation-reflecting core.

22. The method of producing an IR radiation-reflecting pigment of claim 21,
wherein
SiO₂ as metal oxide is applied by a wet-chemical sol-gel process to the IR radiation-reflecting core.

23. The method of producing an IR radiation-reflecting pigment of claim 19,
wherein
a dispersion comprising a volatile organic solvent, IR radiation-reflecting cores, dark color pigments, and at least one material selected from at least one of organic polymers and binders is spray-dried with spraying.

24. A method for producing a material selected from the group consisting of paints, varnishes, printing inks, security inks, textiles, materials for use in military applications, and plastics, wherein the method comprises adding the IR radiation-reflecting pigment of claim 1 to said material.

25. A coating composition
wherein
the coating composition comprises the IR radiation-reflecting pigment of claim 1.

26. The coating composition of claim 25,
wherein
the coating composition is a paint, ink, emulsion paint, or plastic.

27. An article
wherein
the article is coated with the IR radiation-reflecting pigment of claim 1.

28. The IR radiation-reflecting pigment of claim 6, wherein the dark color pigments are present in an amount of 30% to 70% by weight, based on the weight of the total IR radiation-reflecting pigment.

29. The IR radiation-reflecting pigment of claim 7, wherein the dark color pigments are present in an amount of 0.3 to 10 g per 1 m² of the surface area of the IR radiation-reflecting core in the IR radiation-reflecting pigment.

30. The IR radiation-reflecting pigment of claim 7, wherein the dark color pigments are present in an amount of 0.5 to 7 g per 1 m² of the surface area of the IR radiation-reflecting core in the IR radiation-reflecting pigment.

31. The IR radiation-reflecting pigment of claim 13, wherein the metal is selected from the group consisting of aluminum, copper, zinc, iron, silver and alloys thereof.

32. The coating composition of claim 26 wherein the coating composition is an ink and the ink is a printing ink or a security ink.

33. An article, wherein the article is coated with the coating composition of claim 25.
